(19) United States
(12) Patent Application Publication
(10) Pub. No.: US 2003/0185203 A1
(43) Pub. Date: Oct. 2, 2003

(54) Integrated high bandwidth communications system

(75) Inventors: Albert Chow, Hillsdale, NJ (US); Jesse Eugene Russell, Piscataway, NJ (US); Spencer Wang, Parsippany, NJ (US); Wenchu Ying, Cedar Knolls, NJ (US)

Correspondence Address: BANNER & WITCOFF LTD.,, ATTORNEYS FOR AT & T CORP, 1001 G STREET , N.W., ELEVENTH STREET, WASHINGTON, DC, 20001-4597, US

(73) Assignee: AT&T Corp., New York, NY (US)

(21) Appl. No.: 10/393,934

(22) Filed: Mar. 24, 2003

Related U.S. Application Data
(63) Continuation of application No. 09/224,277, filed on Dec. 31, 1998.

(51) Int. Cl. H04L 12/66

(52) U.S. Cl. 370/352

(57) ABSTRACT

A high bandwidth communications system for providing integrated voice, data, multimedia and other subscriber services and applications. Users of the system may select desired services on demand without intervention of the service provider. The services will then be provided over a high bandwidth pipe adequate to meet the needs of the requested services.

### BACKGROUND OF THE INVENTION

The present invention is generally related to the field of telecommunications and more specifically, is directed to a method and apparatus for providing integrated high bandwidth communication services to residential and business telephone subscribers.

Over the years, the demands of telephone subscribers for higher bandwidth communication services has increased dramatically. The increased demand is due in large part to the proliferation of many new communication paths such as cellar telephones, multiple telephone lines in the home, personal facsimile machines, voice mail, e-mail and of course, the emergence of the Internet as an inexpensive communication channel. As subscribers become more acquainted with available services, they naturally begin to see the possibilities for even greater services and perceive a need for them. Such services as video-on-demand and multimedia applications come to mind in this regard.

Telephone service providers are attempting to meet the higher bandwidth demands of their subscribers by squeezing every available bit's worth of information from the existing telephone system infrastructure. The present infrastructure continues to rely in large measure on copper wire lines, i.e., the so-called “twisted-pair”. Twisted-pair lines, however, are typically limited in bandwidth to modem speeds of 56K bits per second.

In order to overcome this bandwidth limitation, some service providers have sought to replace twisted-pair lines with more advanced technologies such as fiber optic cables. The cost of doing so is quite high and is ultimately ineffective unless the entire end-to-end network connection is upgraded as well. Otherwise, the lowest bandwidth link in the network will become a bottle neck and thus limit the overall transmission speed of the end-to-end connection. For example, while the use of fibre optic cabling is popular among some service providers, it is used primarily for network backbones, i.e., the part of the network which carries the heaviest traffic. Fibre optic cabling remains too expensive for subscriber premises terminations. Thus, the higher bandwidth provided by fibre optics cabling is seldom realized by the subscriber as the premises connection is usually still a lower bandwidth twisted-pair line.

Other technologies for providing higher bandwidth include implementing an Integrated Services Digital Network (commonly referred to as “ISDN”) as is well known in the prior art. In its Basic Rate Interface (BRI) configuration, an ISDN can operate as high as 144,000 bits per second. In its Primary Rate Interface (PRI) configuration, an ISDN can operate as high as 1,544,000 bits per second in North America and 2,048,000 bits per second in Europe.

Additional technologies for increased bandwidth over twisted-pair lines include a family of services known in the art collectively as Digital Subscriber Line equipment and services (xDSL). xDSL can be implemented over a conventional twisted-pair line. High bandwidth cable modems also are becoming popular where cable television systems are available. A cable television plant utilizes highly efficient coaxial cable which can carry digital data in addition to a normal video signal. A high bandwidth T1 line may also be implemented at relatively low cost. As known in the prior art, a T1 line uses two twisted-pair lines and can be operated at speeds reaching 1.544M bits per second.

The prior art has not established a precise definition of what bit rate constitutes a “high” bandwidth transmission facility versus a “low” bandwidth transmission facility. The term “broadband” also is used in the art to describe a transmission facility having a bandwidth greater than a voice grade line. As developments in various transmission facsilities continue, higher and higher transmission bit rates will be possible. Thus, the present application is not limited to any particular tranmission rate when such terms as “high bandwidth” and “broadband” are used. The advantages which underlie the present invention apply equally to all of the various transmission facilities without regard to a specific bit transmission rate.

Replacing the existing telecommunications infrastructure in order to provide higher bandwidth is, of course, very expensive. The technologies described above were invented to provide higher bandwidth services and have been available since the early 1980s. However, they remain in large part relatively unused technologies because they lack the capability to provide truly integrated services to telephone subscribers. For example, residential and business subscribers face the same kinds of service limitations today that they faced many years ago. For instance:

1. Voice and data services are basically still non-integrated. The BRI configuration of ISDN was provisioned in the late 1980s to provide higher bandwidth for digital integrated voice and data services. However, it is still a circuit-based and connection oriented narrow band service that lacks the flexibility necessary for connection-less type data inter-networking. It also lacks the higher bandwidth necessary for true broadband applications.

2. Cable television systems provide adequate bandwidth to their customarys, which usually are telephone subscribers as well. Such systems, however, were designed for broadcast based broadband applications with asymmetrical links. Cable systems are, therefore, difficult to upgrade from a networking perspective in order to provision full duplex data and voice applications.

3. Existing service provider networks are still primarily network-centric and call feature application based (e.g., switch centered) which makes new service integration very difficult, if not impossible.

4. Presently, a subscriber must track all the different telephone numbers for the different telephone communication devices they have and must individually pay each of the different service providers accordingly.

As the above summary of the state of the art demonstrates, there are currently no services that deliver integrated voice, data, and multimedia applications cost effectively to the home. In addition, the current paradigm shift in the telecommunication industry from telephone number/circuit-switch centered networking to an Internet Protocol (IP) information packet based networking environment will greatly change ones access to voice and data services in the twenty first century. It is expected that IP based service platforms will drive the future home and business telecommunications environment.

For the above reasons, there is a need in the art for subscriber home and business services which can deliver integrated voice, data, and multimedia application costs effectively. Such a need has remained unmet until the present invention.

### SUMMARY OF THE PRESENT INVENTION

Accordingly, it is an objective of the present invention to obviate the above-noted shortcomings and disadvantages of present methods of delivering subscriber communication services.

It is a further objective of the present invention to provide an improved method of delivering subscriber communication services without imposing inconvenience to the subscriber.

It is a still further objective of the present invention to provide an improved method of delivering subscriber communication services which is economical to implement and simple in operation.

It is a further objective of the present invention to provide an improved method of delivering subscriber communication services which is more economical than prior art approaches.

It is a still further objective of the present invention to provide an improved method of delivering subscriber communication services which can be readily implemented using existing communication networks.

The present invention is described with respect to its application to a residential environment. It should be noted, however, that the invention has equal application to a business environment as well.

In accordance with the present invention, the key subscriber technologies and services can be categorized into the following areas:

1. Narrow band to broadband applications;

2. Wired to wireless with mobility services;

3. Multiple telephone numbers for separate devices to one number for all;

4. Flexibility of rendering new services with best Quality of Service (QoS);

5. Subscriber centered intelligent service applications; and

6. One service provider for all service types, wherein the subscriber need only deal with one entity, i.e., one bill, one customer service department, etc.

A service provider wishing to enter or re-enter the local access services market in order to met the above noted need, must offer adequate bandwidth with integrated services to maximize the use of the bandwidth and address all the local access and service issues identified above. In accordance with the present invention, Applicants have determined that these services must be deployed on an IP based service platform and an IP based network to be compatible with the emerging trends in technology. In order to provide adequate bandwidth to provision integrated data, voice, multimedia and video-on-demand applications at home, Applicants have discovered that a minimum full duplex bandwidth “pipe” of 1.544M bits per second may be necessary. As used herein, and in the prior art with respect to bandwidth, the term “pipe” merely refers to a transmission facility such as the ones discussed above, i.e., fiber optic cable, ISDN, T1 lines, xDSL, coxial cable, etc., and will be referred to hereafter as a “Universal Digital Services pipe” or simply “UDS pipe.”

The integrated system of the present invention can be implemented with a broadband packet access network as the supporting infrastructure that enables the UDS pipe access to the service provider's core backbone network. Such a network is capable of supporting the traditional circuit-switched connection, IP-based connection less packets and mobile IP for personal mobility. It is envisioned that the intelligence of the network will be distributed to the home environment for the subscriber to control how service is rendered. The methodology and the service applications necessary to cost effectively integrate a UDS pipe for local access services with integrated voice, data and multimedia applications from the home is an important objective of the present invention.

The present invention provides a broadband packet access network service architecture for local connectivity which offers integrated high speed information and communication access for business and residential subscribers. In doing so, the present invention fulfills the previously unmet need for such services.

### BRIEF DESCRIPTION OF THE DRAWINGS

The novel features of the present invention are set out with particularity in the appended claims, but the invention will be understood more fully and clearly from the following detailed description of the invention as set forth in the accompanying drawings in which:

FIG. 1 is a block diagram of the service architecture of the present invention;

FIG. 2 is a block diagram of the customer service manager architecture of the present invention;

FIG. 3 is a block diagram illustrating the basic format of an Internet Protocol packet;

FIG. 4 is a more detailed block diagram illustrating the format of an Internet Protocol packet; and

FIG. 5 is a block diagram of the network access manager architecture of the present invention.

### BRIEF DESCRIPTION OF THE PREFERRED EMBODIMENT

A preferred embodiment of the present invention will now be described with reference to the drawings.

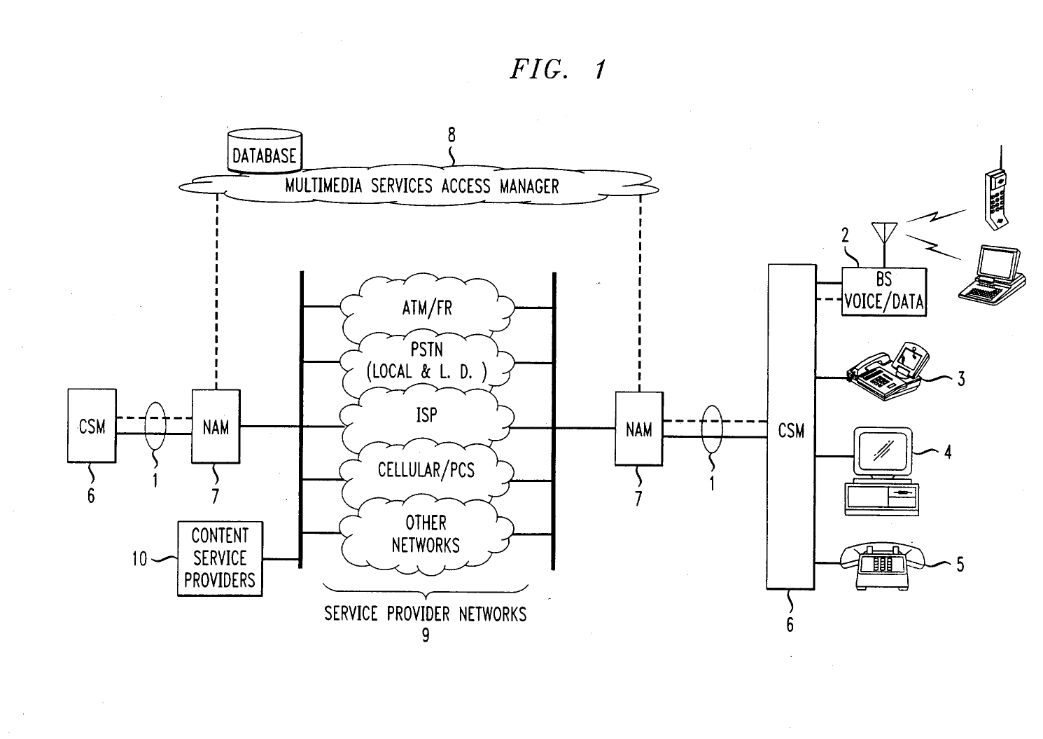

FIG. 1 illustrates a network architecture that integrates broadband subscriber services from a service provider via a UDS pipe 1. In this embodiment, the data transmission rates of the UDS pipe range from low bit rate voice to broadband data and multimedia up to broadband applications depending on the UDS.

In accordance with the present invention, all of the existing Customer Premises Equipment (“CPE”, i.e, equipment not provided to the customer by the service provider) is coupled to a Customer Service Manager (CSM) 6. As shown in FIG. 1, the CPEs may include a remote laptop computer interface 2, video phone 3, computer 4 and telephone 5. As in the typical home environment, the various CPEs may be located in different rooms within the home and are connected to CSM 6 by direct signal wire connection or other suitable means. Other methods of connecting the CPEs to CSM 6 include a secondary connection through the electrical wiring system of the home as is know in the prior art as well as using the existing telephone or cable tevision system wiring as also known in the art.

CSM 6 will typically be provided by the service provider and is installed in the home at a convenient location, such as in the basement or a utility room. The CSM serves as the interface for the network access gatway CPEs located to the home with the UDS pipe provided to the home. The CSM also provides the integration mechanism for integrating all of the services desired by the subscriber. Thus, CSM 6 is a “network edge” device that interconnects a subscriber's home to the service provider's network via UDS pipe 1.

UDS pipe 1 is connected to Network Access Manager (NAM) 7 which is a network edge switch device that provides the switching for the service requests to the service provider's core networks, e.g., ATM/FR, Plain old Switched Telephon Network (PSTN), local and long distance, Internet Service Provider (ISP), (cellular/PCS) and other networks as shown in FIG. 1. The network connections are generally indicated in FIG. 1 by reference No. 9.

Intelligent Multimedia Services Manager (IMSM) 8 provides the network access service intelligence for both CSM 6 and NAM 7. Thus, this broadband packet access architecture creates an access network where the intelligence is distributed to the endpoints of the network and optimizes the service provider's existing transport network based on end-user service requests. This also makes the connection homogeneous to the subscriber.

Also shown in FIG. 1 is a content service providers 10 which is connected to service provider networks 9. Content service providers 10 can provide, for example, multimedia content and e-commerce on demand when a request is made by the subscriber.

The left side of FIG. 1 includes a second NAM 7, a second UDS pipe 1 and a second CSM 6. As shown on the left side of FIG. 1, a plurality of CPEs also would be connected to the second CSM 6 in order to provide an end-to-end connection.

In order to provide integrated services at home, all of the CPEs within the home must be integrated. Integration can be accomplished with high level system and network elements with associated interfaces necessary for each CPE.

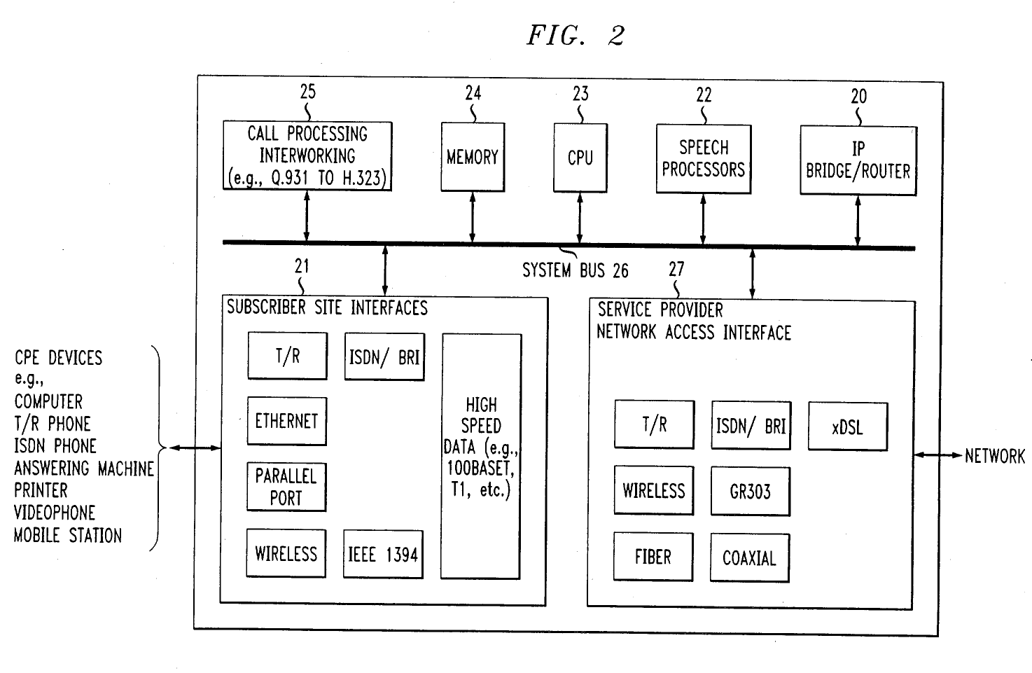

FIG. 2 illustrates one embodiment of the construction of CSM 6. When installed, CSM 6 is non-intrusive in nature to the home and provides “plug-and-play” capabilities for integration of new or additional CPE devices. UDS pipe 1 to which CSM 6 connects will be a high-speed pipe selected from among a number of options, including fiber optic cabling, the coaxial cable used by existing cable television system, ISDN, T1, etc. Once in service, UDS pipe 1 remains online all the time and is always ready to accept services. CSM 6 interacts with NAM 7, the service provider's core network and intelligent networks to provide transaction based services at the home. A subscriber can be billed based on the types, demands on qualities-of-services and the duration of each transaction.

As shown in FIG. 2, the CSM includes a number of inter-related elements, including an IP router 20, a speech processor 22, a CPU 23, memory 24 and a call processsing inter-working unit 25. All of these elements are well known in the art and connect to a bus 26 through which data and process instructions pass between elements. Examples of such buses include TDM, packet bus, high speed packet bus, TCP/IP, 10 base T, 100 base T, fiber optic, depending on the required bandwidth.

CSM 6 also supports two different types of interfaces, the Subscriber Site Interface (SSI) 21 for the home CPEs and the Service Provider Network Access Interface (SPNAI) 27 for service provider network resources via UDS pipe 1.

SSI 21 provides local access to the CPEs that may consist of existing residential T/R phone, ISDN/BRI phone, computer modem, fax machine, wireless residential base station (e.g., extension of public cellular service to home, PCS) and LAN, etc. SSI 21 provides forward and backward CPEs access compatibility.

SPNAI 27 provides connectivity to UDS pipe 1. CSM 6 is able to suport the various transport technologies implemented for the UDS pipe. CSM 6 converts all information (i.e., voice, data, multimedia and video) into packet (e.g., IP over ATM or voice over IP) based medium for transport to/from the NAM.

The present invention is described with respect to the use of the Internet Protocol (IP) as the vehicle for information transport between CSM 6 and NAM 7. This is by way of example only and other transmission protocols and formats may be used as well. The IP protocol will now be explained.

In modern network communications, data is typically sent from one point to another using established protocols and standards. These protocols and standards allow equipment from various manufacturers and of various designs to exchange data without the need for special interfaces or conversion processes and the like.

A well established way of sending data over a computer network is to partition the data into small packets having a regular format. Each packet, also known in the art as a datagram, includes an electronic address which is used to route the packet across the network to its designation. The packets are then reassembled at the destination and the data restored to its original or some other prearranged format.

Data communications over the Internet, for example, are conducted in accordance with the Internet Protocol (IP) suite. The IP suite provides for the transmission of packets from source to destination through the various interconnected networks which form the Internet. While the IP suite does not guarantee delivery of each packet, the integrity of the data carried by the packet, or the order in which the packets arrive at the destination, it does provide error protection for some of the critical information within the packet.

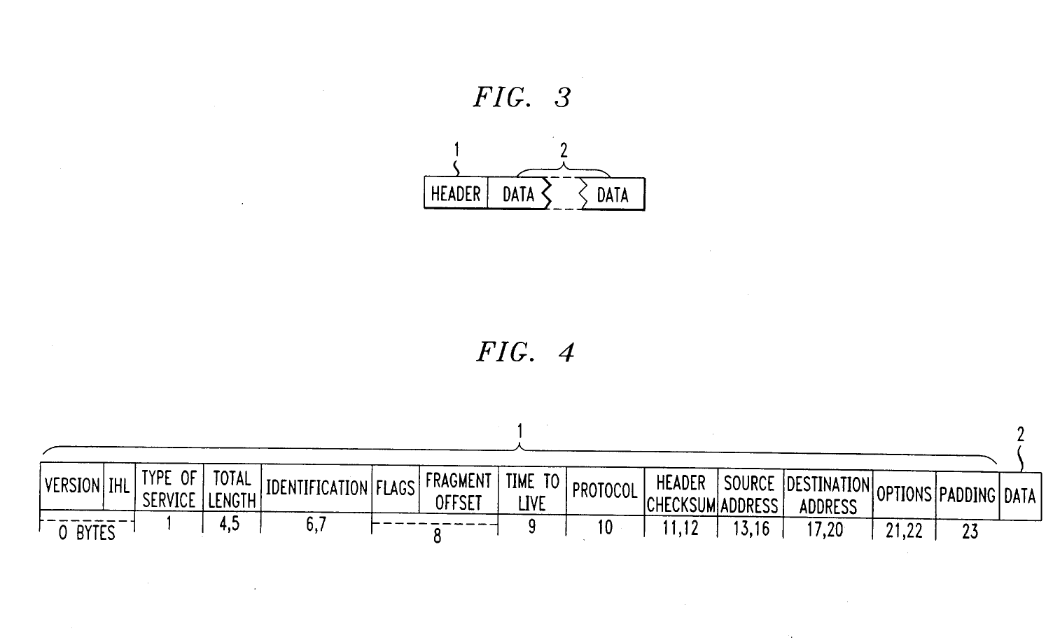

FIG. 3 illustrates the format of an IP packet. The packet includes a header portion 1, which carries control information about the packet, and data portion 2, which contains the data being carried by the packet. Header portion 1 typically has a fixed format and length while data portion 2 may vary in length.

FIG. 4 is a more detailed illustration of the format of an IP packet with header portion 1 and data portion 2. As shown in FIG. 4, Byte 0 of header 1 includes a 4-bit Version field which indicates the format of the Internet header and a 4-bit Internet Header Length (IHL) field which indicates the length of the Internet header in 32-bit words.

Byte 1 is an 8-bit Type Of Service Field which indicates the type of service which is to be given to the packet.

Bytes 4 and 5 form a 16-bit Total Length field which indicates the total length of the packet (including header and data) measured in octets.

Bytes 6 and 7 form a 16-bit Identification fields which contains a value assigned by the sending device to aid in assembling the packets.

Byte 8 includes a 3-bit Flags field which contains flags controlling fragmentation of the packet and a 13 bit Fragment Offset field which indicates where in the packet this fragment belongs.

Byte 9 is an 8-bit Time To Live field which places a limit on the life span of the packet.

Byte 10 is an 8-bit Protocol field which indicates the protocol associated with the data in the data portion of the packet.

Bytes 11 and 12 form a 16-bit Header Checksum field which represents a checksum computed on the packet header field only.

Bytes 13-16 contain a 32-bit IP address which specifies the Source Address of the packet.

Bytes 17-20 contain a 32-bit IP address which specifies the Destination Address of the packet.

Bytes 21-22 form a variable length Option field.

Byte 23 is a Padding field.

The source and destination IP addresses contained in the packet header are divided into two fields, a network-identifier and a host-identifier. The network-identifier specifies a particular physical network in the Internet and the host-identifier specifies a particular device attached to the specified physical network.

In order to reach its destination, an IP packet may have to traverse a variety of different physical networks. While an IP packet is in a given physical network, it is transported in the same manner that the physical network transports any kind of data. For example, one common kind of physical network is a local area network (LAN) which uses the Ethernet® protocol. In the Ethernet protocol, data moves in packets called “frames”. Each frame has a preamble; a destination Ethernet address; a source Ethernet address; an ether type field, which specifies a type of the protocol; a data field, which carries the data; and a frame check sequence, which is an error checking code. When an Ethernet frame is carrying an IP packet, such as illustrated in FIG. 3, the packet simply occupies the data field of the frame.

The present invention utilizes the above identified IP packet to provide control and data flow between CSM 6, NAM 7 and many of the CPEs connected to CSM 6.

The following list some of the key service related responsibilities of CSM 6:

1. Integration of CPEs including the capability to route voice/data traffic among the local CPEs (e.g., LAN emulation);

2. Provide intelligent IP dial-tone services platform to enable fast service offerings to the user;

3. Provide power source (e.g., T/R phone) and network timing (e.g., ISDN/BRI) to the CPEs when necessary;

4. Provide intelligence for transaction based service applications;

5. Provide residential subscriber database management (e.g., profile etc.);

6. Provide call feature, service activation and support (e.g., multiple way conferencing, CODEC, echo cancellation, voice-mail, e-mail, routing, call feature applications, routing of calls, mobility management, etc.);

7. Provide build-in diagnostic and maintenance capability;

8. Provide interfaces to subscriber site access equipment Interfaces, e.g., T/R phone, ISDN phone, computer, video phone, printer, etc.;

9. Provide interfaces for network access, e.g., wireless, HFC, xSDL, fiber optic and coaxial cable, T1, ISDN, etc.

10. Distributed call processing capability such as channel management;

11. Provides efficient bandwidth allocation to the NAM;

12. Mail system for e-mail, voice mail, and multimedia mail (sending, receiving, and storing);

13. IP proxy server;

14. Analog—digital conversion;

15. Conversion between circuit-oriented connection to IP-based packets support connection-oriented and connection transactions;

16. Intelligence to communicate with the network access manager;

17. CSM keeps a log of all incoming and outgoing requests;

18. Dynamic bandwidth allocation (7 Kbps to 1.544) based service request and subscriber profile;

19. Transport selection based on service request and subscriber profile;

20. User programmable interface that can also be accessed remotely, including speech recognition and conversion between text and speech;

21. Provide power source;

22. Provide network timing (e.g., ISDN/BRI) to the CPEs when necessary;

23. Answering machine;

24. Customer site service creation platform.

25. Distributed call processing;

26. Billing support;

27. Mobility/roaming support;

28. Voice prompt;

29. CPE-Interfaces;

30. Local diagnostic capability; and

31. Man machine interface based on RS-232 connectivity to CPE personal computer.

The features of CSM 6 are fully realized when it is used, for example, in conjunction with a video phone. A video phone may support the following capabilities and additional capabilities:

1. Electronic address book and associated functions of entry, lookup, deletion, and modification;

2. Supports multiple lines;

3. Intelligent conversant menu system that is user friendly;

4. Speech recognition for access to the video phone features; and

5. Security features for phone features e.g., mail system, address book, outgoing calls, etc.

The CSM hardware may, for example, comprise:

1. Touch screen display;

2. Alphanumeric keypad;

3. CPU, memory, power supply, high speed interface, signal processor;

4. Function keys (e.g., page up, page down, scroll arrows, call hold, mute, redial, calling line indication (for support of multiple line feature), call forward, redial, conference, hold, drop, etc);

5. Support for a printer;

6. Speech synthesizer;

7. Handset (can be wired or wireless);

8. Video camera;

9. Speakers; and

10. Microphone.

The CSM may also be constructed without a subscriber interface, such as the above noted touch screen display, keypad and function keys, but instead be provided with and RS-232 interface which would enable the CSM to be programmed and managed remotely from, for example, a PC running appropriate CSM management software. In this embodiment, the CSM management software would interface with appropriate control software resident in the CSM. Other remote interfaces may be used as well.

The UDS pipe can be realized in many existing or future transport technologies including:

1. Twisted Pair, for instance XDSL, T1, etc.

2. Hybrid Fiber Coaxial, for instance HFC, etc.

3. Fixed Wireless access, for instance microwave, etc.

4. Free Space Optics

5. Fiber to the home

6. Coaxial to the home

Regardless of the type of transport technology used at the physical layer, the UDS will provide virtual channel connections to serve multiple service transactions simultaneously between CSM 6 and NAM 7. CSM 6 supports dynamic bandwidth allocation by the subscriber from as low as 7 kbps (e.g., low-bit-rate-voice, LBRV) up to minimum of 1.536M bits per second depending on the type of UDS used (e.g., XDSL, HDSL-2, etc) and the transaction types (e.g. voice, highspeed file transfer and video-on-demand). The following list some of the key services related responsibilities of UDS pipe 1:

1. Support quality (at minimum 10×10⁶ BER or better) and accuracy of transportation

2. Support different transport medium both at the physical and link layer

3. Support connection and connection less transactions

4. Support network synchronization

5. Dynamic bandwidth allocation based on intelligent network signaling control (real time interactive signaling) and user requested services.

NAM 7 is the service provider's core network access edge switch device for the subtending CSMs. NAM 7 is an edge switch device because it sits between service provider's core networks and the CSMs.

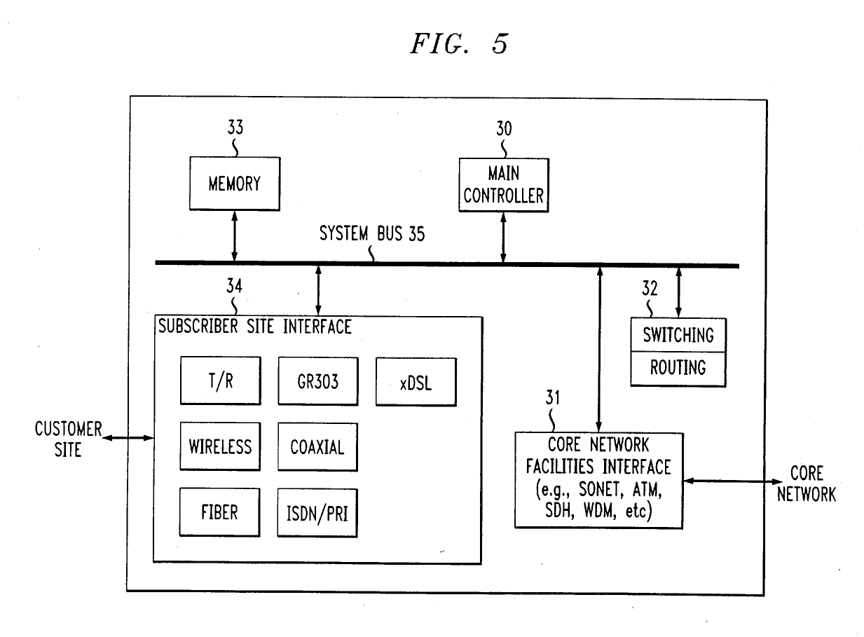

FIG. 5 is a block diagram of one embodiment of NAM 7. As FIG. 5 illustrates, NAM 7 includes a number of inter-related elements, including main controller or CPU 30, memory 33 and switch 32, all of which are connected to system buss 35. Switch 32 provides call switching and message routing as known in the prior art.

Also connected to system buss 25 is Core Network Facilities Interface 31 which interfaces NAM 7 to the service provider's core networks as shown in FIG. 1. Residential Interface 34, also connected to system buss 35, interfaces NAM 7 to CSM 6 as shwon in FIG. 6.

NAM 7 converts all the transaction based virtual channels from the CSM into the destination network standard format (e.g., 64 Kpbs/PCM) for voice circuit switch traffic to provide end-to-end service applications. NAM's key responsibilities are to provide switching/routing and transport for transaction based services between CSM and the service provider's core networks. It will interact with IMSM 8 shown in FIG. 1 to provide call and feature applications to the home. The following list some of the key service related responsibilities of NAM:

1. Provide Inter-Working-Functions between CSM 6 and the service provider's core networks (including, for example, ATM/FR, PSTN, ISP, Cellular/PCS and other networks as shown in FIG. 1) for circuit and packet switching for voice, data and multimedia applications.

2. Provide multiplexing and de-multiplexing and switching/transport of transaction based services applications.

3. Provide voice CODEC for circuit and IP-based voice transactions when necessary.

4. Provide network synchronization to the RSMS.

5. Provide signaling interfaces to the IMSM.

6. Interwork with the IMSM for subscriber registration, authentication, DN and IP call routing and feature applications.

7. Support OAM&P services for IMSM.

8. Provides connection management for distributed call processing targeted for multimedia services applications.

9. Call processing interworkings (e.g., Q.931 to H.323,Q.931 to TCP/IP, etc).

IMSM 8, as shown in FIG. 1, provides the distributed network intelligence to the CSMs via the NAMS. IMSM 8 is the service control point for the broadband packet access network where subscriber database related to the service profile and network operation parameters are stored. IMSM 8 is a new service provider core network element to be deployed to provide high bandwidth services to the home for integration of voice, data, multimedia and video services. IMSM 8 will interact with other service provider core network intelligent nodes (e.g., SCP, HLR, Gatekeep/H.323, etc.) for services delivery and creation. The following list some of the key services related responsibilities of the IMSM:

1. Provide services creation environment, service management system and call feature application.

2. Provide subscriber database management.

3, Provide end-to-end signaling interfaces between CSM and the service provider core network intelligent nodes when necessary (e.g., security related to subscriber authentication data).

4. Provide call management for distributed call processing and information routing processes.

The following service scenarios describe the key service concept envisioned for the integrated services system of the present invention.

Subscriber Needs Only One Telephone Number

Presently, there is an abundance of telephone numbers associated with each of the telecommunication devices used by the consumer: home number, cellular number, pager number, facsimile number, email address, and personal number.

The need for multiple telephone numbers is eliminated with the present invention. In accordance with the invention, a customer number is associated with the CSM, known as the CSM number (CSMN) Subscribers are reachable anytime and anywhere via their CSM). Instead of giving subscribers a home phone number, a work number, a pager number, cellular number, email address, etc. The subscriber merely has to give their CSMN. One possible format for a CSMN is that of a conventional directory telephone number (DN), but this does not rule out other formats such as IP addresses. Multiple DNs and IP addresses all map into an CSMN. The CSM and the network handle this mapping; it is transparent to the subscriber.

Consider the following scenario of service fulfillment by the CSM:

1. Ted's house has an CSM with a CSMN of 555-1111. Paul's house has an CSM with a CSMN of 555-2222.

2. Ted is using his video-phone and tells his CSM to call Paul for video-telephony. His CSM finds Paul's CSMN, 555-2222, in the CSM's address book stored, for example, in a database within memory 24 shown in FIG. 2 and sends a signaling request to the network to Paul's CSM.

3. When Paul's CSM detects the incoming request, it will parse the signaling to determine who is the request for, the type of request, and other service data. The CSM will determine that Paul is available to receive such a request, (i.e., Paul has not informed the CSM to redirect his calls) and will acknowledge the request, allocate the bandwidth from the UDS pipe (e.g., 384 Kbps), and direct the call to Paul's video-telephone. Ted's CSM will receive the acknowledgement, allocate the bandwidth from Ted's UDS pipe (e.g., 384 Kbps) and inform Ted that Paul's phone is ringing. When Paul answers the call, Ted and Paul see and talk to each other.

During Ted's conversation with Paul, the two involved CSMs receives multiple requests for additional services. Several such examples are describe below with respect to requests coming into Ted's CSM:

1. CSM receives an incoming request and determines that the request is for Ted's son John. The CSM can do so by providing a voice prompt to the caller to select from a menu the name of the person being called. If the caller selects John, then the CSM sends the call to the phone in John's room. John does not answer the phone, CSM informs the caller that John is not available and the caller is redirected to a voice mail system.

2. CSM receives an incoming request and determines that the request is for Ted's daughter, Jane. Jane is shopping in the mall, and has taken her cellular phone with her. Jane had previously programmed Ted's CSM to direct calls for her to her cellular phone. CSM tells the network that the incoming request should be redirected to the cellular phone. The cellular network checks its databases and routes the request to her in the mall.

3. CSM receives an incoming request and determines that the request is for Ted's wife, Anna. Anna is shopping in the grocery store, she is waiting for an important fax to arrive. Anna has programmed the CSM to send the fax to her computer and to send her a message of its arrival on her cellular phone. When CSM determines that the incoming request is a fax for Anna, CSM sends the fax to Anna's PC and sends a request to the cellular network to send a message to Anna's cellular phone. The cellular network locates Anna's phone and sends an SMS message indicating fax arrival.

4. CSM receives an incoming request and determines that the request is for Ted. CSM knows that Ted is on another call, if Ted activated the call interruption feature, i.e., if the intended callee is active on another “line”, the callee can be interrupted by some alerting tones/message, unlike call waiting, call interruption is intended for a specific person. Ted has activated the call interruption feature. CSM allocates additional bandwidth for the second call. Ted switches to the voice new call, it is from Anna, reminding him to start dinner, and to please print her fax for her. Ted ends his conversation with Anna, and switches back to Paul. CSM releases the bandwidth previously allocated for Anna.

5. Ted's son, John, decides to go on-line to chat on his laptop. CSM sends a signaling request to his ISP to establish a session. John's default bandwidth is 128 Kbps, which can be overridden at request time. This is a packet-based session, the laptop's IP address is subtending to the CSMN and the CSM is the laptop's home node. John decides to bring his laptop to visit his friend Ron a couple of blocks away. When John uses the wireless modem on his laptop to go on-line, Ron's CSM will send a signaling message to John's CSM indicating the new IP address for the laptop, i.e., Ron's CSM is the foreign agent sending the care-of-address which is Ron's CSMN, to John's CSM. Any messages to John's laptop will be re-routed (tunneled) from John's CSM (home node) to the Ron's CSM (visited node).

The above scenarios illustrates the following advantages of the present invention:

1. Multiple phone numbers subtending to the CSMN. No need for the user to remember or to inform people of these phone numbers. At initialization time of the CSM or the new device, the user can program the numbers into the CSM or they can be downloaded from the network's customer care center. The network and the CSM use these device specific numbers for routing purposes. The number that appears for the caller identification feature is the CSMN. When a user dials an CSMN, he/she can be connected to any number of devices/people in the home. If the device/person is mobile, CSM is responsible for informing the network and the network will transfer the call to reach the device/person. The CSMN will allow the service provider to provide more user friendly services based on a single CSMN, therefore the CSMN will be the universal number for the entire house hold members.

2. The CSM stores routing information for devices/people in the household. It is a residential service control point for household members and their devices. The CSM is programmable for an individual and household profile. Users can tell the CSM that they are reachable on their cellular phone, work number, hotel number, etc. The CSM is comparable to a personal 800 database. This moves the intelligence of the Intelligent Network from network-centric-based to a distributed residential-based.

For the IP-based environment, the CSM is also the home node for the residential IP device. The CSM also has the home agent and the foreign agent to support mobile IP.

3. The CSM service concept will save not only caller's money and time, it can also save the service provider core network resources. Since the CSM is an intelligent device at home, it can negotiate with other CSM via signaling prior to an actual call will be made. For instance, without the CSM be installed at home, a caller must make a phone call first before finding out that the callee is not available. With the CSM and its build-in intelligence; a signaling path can be established between source and destination CSM to find out whether the callee will be available to make the call before the actual call is made to save core network resource. For example, caller A calls B in England from New York and B's daughter answered the phone and indicating to A that her dad is away in Paris and can be reached at number XYZ. Caller A must again call XYZ to reach B and even then caller A can not be sure he'll find B. If the CSM is installed at both callers' home, a signaling communication can be established to locate B prior to when the actual call is made.

4. The location of the callee is secured, i.e., location privacy. Since the network is about to route the call wherever the person is, the caller does not know where the callee is until specifically informed by the callee. Referring to previous example, caller A does not know that callee B is in Paris. Caller A knows only that caller B is reachable by their CSM number.

5. The CSM with the UDS pipe enables the transmission of any service. It enables multiple simultaneous sessions. Bandwidth is allocated and freed to this UDS pipe. The CSM can also select the best transport medium for the QoS and the bandwidth and billing desired by the customer for reception of a service.

6. The request can be routed to the destination party wherever they are if the party wishes to be reached using the signaling path.

7. “Lines” are allocated dynamically. There is no call waiting feature as we know it today.

8. Backward compatibility of existing consumer telecommunications devices.

CSM Provisioning Scenario

Presently, if the consumers wish to add another line, new type of service, they have to invest considerable time and monies.

In accordance with the present invention, the UDS pipe is provisioned from the beginning of service initialization. The pipe is capable of supporting any number of connection or connectionless sessions until the bandwidth is exhausted. The traditional concept of adding telephone lines to the home is no longer applicable.

To add another phone extension to the CSM, the consumer buys a phone interface module, e.g., PCMCIA card or any futuristic phone/voice communication adapter module/card from their local store (electronics or grocery store), plugs it into the CSM, and connects the new phone into the CSM. The CSM automatically registers that new device is connected and the consumer programs the new phone characteristics into CSM, for example, the phone is for the daughter, Jane, and directs unanswered calls to the answering machine.

When the subscriber buys a new wireless phone from the local electronics store, he tells the salesperson to register for service with a desired wireless service provider and to associate the wireless phone with his CSMN. The service provider will activate the phone for service and will establish a signaling connection to service provider to download the wireless phone number to the subscriber's CSM. The subscriber at this point can call the CSMN and program it to direct all of his calls to his wireless phone and for instance, PCS/cellular, wireless ATM, third generation wireless communications devices, etc.

Alternately, if the phone supports over the air activation, he merely needs to buy the phone and register the phone for service over the air upon power up.

The service creation environment and the plug and play capability of the CSM enables the subscriber to interact with the intelligent multimedia service manage to dynamically create, modify or remove services instantaneously.

Integrated Mail

Most people currently have to check different systems for reception of mail. They have to check their voice mail system for voice mail, check their mailbox for paper mail, and check their computers for email.

In accordance with the present invention, subscriber benefit from a service where all mail, i.e., voice and email are received by the CSM. Also, instead of the current paper mail being delivered to a street address, it is delivered to the CSMN in electronic format, i.e., email. That is, sales circulars from the department stores are sent to Resident at 555-1234 versus Resident at 1234 Main Street USA. Users do not need to give their people street address or email address along with the phone numbers. Just one number the CSMN can be used to reach people anytime, anywhere, in any format. Users can just access their CSM to check for mail.

The CSM presents a list of mail messages, mail type (voice/text/multimedia), origination (DN/IP address/name), recipient data (DN/name), and optional for email, header info. The CSM has security measures that permit private messages (designated by the sender and/or receiver) to be accessed only by the correct password. The recipient can also specify all mail to be private. Subscribers can:

1. Listen to a voice mail message, and choose to delete it, save it on the CSM, send it to their voice mail system, convert to text, or forward it to another destination.

2. Read a mail, and choose to delete it, save it on the CSM, respond to it, send it to their computer mail system, print it, convert to speech, or forward it to another destination.

Users can also direct the CSM to direct all mail to the computers, or filter them and direct subset to specific computers, and likewise for voice mail.

When Ted accesses the mail on his CSM, he sees several messages:

1. A voice message for his wife Anna from her friend Pat

2. A voice message for his daughter Jane that is marked private

3. A multimedia sales circular from the local grocery store

4. A text message for Ted from a work colleague

5. A multimedia message for Ted for a preapproved credit card application

6. A text message for Anna with the New York Times excerpts that she subscribes to.

Ted immediately deletes the junk mail (credit card application) and responds to his colleague's mail and forwards the mail to his computer at work.

Anna uses her cellular phone to call the CSMN to access her mail. She listens and deletes Pat's voice mail. She asks the CSM to read the NY Times excerpts, and print it out.

In accordance with the present invention, the use of a single telephone number scenario discussed above is applicable for mail addresses as well not just phone numbers. Users are reachable anytime, anywhere, and in any format. The CSMN has subtending DNs and IP addresses.

In addition the CSM can receive mail in voice, text, and multimedia formats. CSM can convert the mail among the various formats. Security measures in CSM prevent fraudulent access to mail.

It should be obvious from the above-discussed apparatus embodiment that numerous other variations and modifications of the apparatus of this invention are possible, and such will readily occur to those skilled in the art. Accordingly, the scope of this invention is not to be limited to the embodiment disclosed, but is to include any such embodiments as may be encompassed within the scope of the claims appended hereto.

We claim:

1. A method of integrating subscriber services in a high bandwidth communications system, said method comprising the steps of:
providing a high bandwidth connection to said subscriber's site;
providing an interface module between said high bandwidth connection and subscriber devices to which said subscriber services are to be provided, wherein said subscriber can select said services on demand.
